(19) United States
(12) Patent Application Publication
(10) Pub. No.: US 2016/0129518 A1
(43) Pub. Date: May 12, 2016

(54) Method and Apparatus for Air Carbon Arc Cutting

(71) Applicant: ILLINOIS TOOL WORKS INC., Glenview, IL (US)

(72) Inventors: Quinn W. Schartner, Kaukauna, WI (US); Bernard J. Vogel, Troy, OH (US); Andrew D. Nelson, Grand Chute, WI (US)

(73) Assignee: ILLINOIS TOOL WORKS INC., Glenview, IL (US)

(21) Appl. No.: 14/536,140

(22) Filed: Nov. 7, 2014

(51) Int. Cl. B23K 9/10; B23K 9/067; B23K 9/013

(52) U.S. Cl. CPC B23K 9/1006; B23K 9/013; B23K 9/067

(57) ABSTRACT

A method and apparatus for air carbon arc cutting (CAC-A) using a welding-type power supply includes selecting a CAC-A mode and providing current in a CAC-A mode at a selected current setpoint. Start and restrike algorithms can be used that are specifically for CAC-A.

### FIELD OF THE INVENTION

The present disclosure relates generally to the art of welding type power supplies and providing welding type power. More specifically, it relates to welding type power supplies used for air carbon arc cutting and providing welding type power for air carbon arc cutting.

### BACKGROUND OF THE INVENTION

There are many known types of welding-type power supplies. Welding-type power, as used herein, refers to power suitable for electric arc welding, plasma arc cutting or induction heating. Welding type system, as used herein, is a system that can provide welding type power, and can include control and power circuitry, wire feeders, and ancillary equipment. Welding-type power supply, as used herein, is a power supply that can provide welding type power.

Providing welding-type power, and designing systems to provide welding type power, provides unique challenges. Welding type systems will often be moved from one location to another, and be used with different inputs, such as single or three phase, or 115 V, 230 V, 460 V, 575 V, etc., or 50 hz or 60 hz signals. Power supplies that are designed for a single input cannot provide a consistent output across different input voltages, and components in these power supplies that operate safely at a particular input level can be damaged when operating at an alternative input level. Also, power supplies for most fields are designed for relatively steady loads. Welding, on the other hand, is a very dynamic process and numerous variables affect output current and load, such as arc length, electrode type, shield type, air currents, dirt on the work piece, puddle size, weld orientation, operator technique, and lastly the type of welding process determined to be most suitable for the application. These variables constantly change, and lead to a constantly changing and unpredictable output current and voltage. Power supplies for many fields are designed for low-power outputs. Welding-type power supplies are high power and present many problems, such as switching losses, line losses, heat damage, inductive losses, and the creation of electromagnetic interference. Accordingly, welding-type power supply designers face many unique challenges.

Additionally, welding-type power supplies or systems are often sold for one or more particular processes, such as stick, TIG, MIG, pulse, sub-arc, heating, cutting, and the maximum output power or current can be anywhere from one hundred or less amps, to five hundred or more. Some welding processes are performed using a cc output (controlled current), and others using a CV output (controlled voltage). Welding type power supplies dedicated to a single process and a single output are easier to design. However, many users prefer welding type power supplies that are multi-process so as to avoid having one power supply for each process.

There are many different topologies used in welding type power supplies. Switched power supplies are often used to allow for output control. One prior art welding type power supply that is useful for a variety pf processes is described in patent application Ser. No. 13/839235, published as US-2014-0021180-A1, hereby incorporated by reference. This power supply is well suited for controlling the output using pulse width modulation of the output inverters. It includes a preregulator, a high voltage split bus, and a stacked inverter output. Another prior art welding type power supply well suited for pwm control of the output is described in U.S. Pat. No. 8,455,794, also incorporated by reference.

One welding type process performed is CAC-A (air carbon arc cutting). CAC-A involves using a carbon-graphite electrode, and the arc between the electrode and the workpiece melts a portion of the metal, while a jet of air is passed through the arc to blow away the molten metal. The process is used for cutting and gouging, and it can be done manually or mechanized. CAC-A is performed on prior art welding power supplies using a stick mode, or a CV mode. Prior art welding type power supplies do not include a CAC-A mode. CAC-A mode, as used herein refers to a mode of a welding-type power supply that is dedicated to CAC-A (air carbon arc cutting), and includes a control scheme used for CAC-A.

Because prior art welding type power supplies do not have a CAC-A mode, the control and output power are not designed for CAC-A, and the process can be difficult. There are different CAC-A techniques, including skimming along the surface to smooth the surface, pecking at the surface to remove small areas, and gauging large areas. Providing power for CAC-A can be troublesome, because pecking and skimming can include brief arc outages. CAC-A starts can be particularly difficult when using a welding-type power supply because the start algorithm will be for another process (such as stick). Also, changes in current output will be tailored for another process (such as stick) rather than for CAC-A. Accordingly, a welding-type power supply that includes a CAC-A mode is desired. Preferably, it will include a start algorithm that is suitable for CAC-A.

### SUMMARY OF THE PRESENT INVENTION

According to a first aspect of the disclosure a method of air carbon arc cutting using a welding-type power supply comprises selecting a CAC-A mode and a selected current setpoint, and disabling stick droop in the output. A CAC-A dig slope that is greater than a stick dig slope and a CAC-A dig threshold that is greater than a stick dig threshold are set. A CAC-A hot start current that is greater than a stick hot start current and a CAC-A hot start time, and a CAC-A hot start delay time are set. A CAC-A start current that is greater than the current set point and a CAC-A start current time are set. A CAC-A slew rate that is less than a stick slew rate is also set. Power is provided using the welding-type power supply, such that when an open circuit is detected and then current is detected within the hot start delay time, the CAC-A start current is provided for the CAC-A start current time. When the current is above the CAC-A dig threshold and after the CAC-A start current time, the current is increased at the CAC-A slew rate until the current is provided at the current setpoint. When an open circuit is detected and current is not detected within the hot start delay time, a hot start current is provided for the CAC-A hot start time. When an open circuit is detected and current is not detected within the hot start delay time, and the output voltage is less than the CAC-A dig threshold, the CAC-A hot start time is increased.

According to a second aspect of the disclosure a method of air carbon arc cutting (CAC-A) using a welding-type power supply to provide an output includes selecting a CAC-A mode and providing current in a CAC-A mode at a selected current setpoint.

According to a third aspect of the disclosure a welding-type power supply includes a user mode selector, including an air carbon arc cutting (CAC-A) mode, a power circuit that receives input power and provides CAC-A power, and that has a control input, and a controller that has a control output connected to the control input. The controller has a CAC-A control module responsive to the CAC-A mode and has feedback indicative of the output current and/or indicative of the output voltage.

The stick droop in the output is disabled when in the CAC-A mode in one embodiment.

A CAC-A dig slope that is greater than a stick dig slope and a CAC-A dig threshold that is greater than a stick dig threshold are set, and output is provided at the dig slope when the output voltage is less than the dig threshold. in various embodiments.

The CAC-A dig slope is about 30 amps/volt and the CAC-A dig threshold is about 25 volts in one alternative.

The CAC-A hot start current is greater than a stick hot start current, a CAC-A hot start time and a CAC-A hot start delay time are set, and when an open circuit is detected and current is not detected within the hot start delay time, a hot start current is provided for the CAC-A hot start time in another alternative.

The CAC-A dig slope is at least 24 amps/volt, the CAC-A dig threshold is at least 23 volts, the CAC-A hot start current is about twice the current set point, the CAC-A hot start time is about 100 msec, the CAC-A hot start delay time is at least 150 msec, the CAC-A start current is at least 10% is greater than the current set point, the CAC-A start current time is about 10 msec and the CAC-A slew rate is about 125 amps/msec in one alternative.

The CAC-A hot start current is about twice the current set point, the CAC-A hot start time is about 100 msec, and the CAC-A hot start delay time is about 200 msec in one embodiment.

When an open circuit is detected and current is not detected within the hot start delay time, and the output voltage is less than the CAC-A dig threshold, the CAC-A hot start time is increased in various embodiments.

The CAC-A start current is about 12.5% greater than the current set point and the CAC-A start current time is about 10 msec, and the CAC-A slew rate is about 125 amps/msec or 200 amps/msec in various alternatives.

When an open circuit is detected and current is detected within the hot start delay time, a CAC-A start current is provided for a CAC-A start current time, and then the current is increased at a CAC-A slew rate until the current is provided at the current setpoint in another alternative.

The CAC-A control module includes a CAC-A start module in one embodiment.

The CAC-A control module includes a CAC-A dig module having a dig threshold that is greater than a stick dig threshold, and having a dig slope in various embodiments.

The CAC-A start module includes a CAC-A hot start current that is greater than a stick hot start current, a CAC-A hot start time, a CAC-A hot start delay time, responsive to the feedback input in another embodiment.

The CAC-A start module includes a CAC-A increased hot start module, responsive to the output voltage being less than a CAC-A dig threshold. in one embodiment.

The CAC-A start module includes a weld start module having a CAC-A start current time and a CAC-A slew rate, and is responsive to the feedback input in various embodiments.

The CAC-A control module includes a droop disable module in another embodiment.

Other principal features and advantages of will become apparent to those skilled in the art upon review of the following drawings, the detailed description and the appended claims.

### BRIEF DESCRIPTION OF THE DRAWINGS

FIG. 1 is block diagram of a welding-type power supply; and

FIG. 2 is a controller used for the welding-type power supply of FIG. 1.

Before explaining at least one embodiment in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present disclosure will be illustrated with reference to a particular welding-type power supply, power circuit, controller and control modules, it should be understood at the outset that other welding-type power supplies, power circuits, controllers and control modules can also be used to implement the invention.

Generally, a welding-type power supply includes a mode of operation specifically designed for CAC-A, in which CAC-A power is provided. The arc starting and the closed loop control is particularly well suited for CAC-A. A user mode selector, such as on the front panel of the welding-type power supply, allows the user to specify that the output should be for CAC-A. The preferred embodiment provides that other modes include stick, TIG, MIG, and that CC or CV can be provided.

The preferred embodiment provides that, when in the CAC-A mode the droop usually provided for a stick mode is disabled. This allows the VA curve in CAC-A mode to extend to the full capacity of the unit, instead of drooping as the voltage rises above 30 V. The drooping characteristic reduces the available power, which is typically not beneficial for CAC-A.

The CAC-A mode, in the preferred embodiment, also has a CAC-A dig threshold that is about 23 to about 25 volts—which is greater than the typical 18.5 V stick dig threshold. The CAC-A dig slope is about 24 to 30 amps/volt, which is greater than the typical 8 amps/volt stick dig slope). This improves short circuit clearing, particularly with long weld cables. Alternatives provide for using other CAC-A dig thresholds and other CAC-A dig slopes, although it is preferred they be greater than the stick values. CAC-A dig slope, as used herein is the slope of the dig V-A curve when in a CAC-A mode. CAC-A dig threshold, as used herein is the threshold below which a CAC-A dig V-A curve is used when in a CAC-A mode. About, when referring to a parameter as used herein, refers to +/−10%. Stick dig slope, as used herein is the slope of the dig V-A curve when in a stick mode. Stick dig threshold, as used herein is the threshold below which a stick dig V-A curve is used when in a stick mode.

Restrike logic specifically for CAC-A is provided in the CAC-A mode, in the preferred embodiment. The dedicated restrike/start provides versatility on various CAC-A techniques (normal, skim, peck). Hot start works well to initialize an arc, but is more difficult to control for skimming. The preferred embodiment provides a combination of hot start and “light” hot start and a unique weld start state that is well suited for both skimming an pecking.

The preferred embodiment provides that a CAC-A hot start state includes an initial CAC-A hot start current that is about twice the stick hot start current. Other CAC-A hot start currents can be provided, including current closer to the stick hot start magnitude. The CAC-A hot start current is preferably greater than the stick hot start current. CAC-A hot start current, as used herein is the hot start current when in a CAC-A mode. Stick hot start current, as used herein is the hot start current when in a stick mode.

The CAC-A hot start current is provided for CAC-A hot start time. The preferred CAC-A hot start time is about 100 msec, or up to about 150 msec in other embodiments. The CAC-A hot start time is extended if the output voltage is below the CAC-A dig threshold. CAC-A hot start time, as used herein is the time during which a hot start current is provided when in a CAC-A mode. Alternatives provide for not extending the CAC-A hot start time, and/or using a different CAC-A hot start time.

CAC-A restrikes are handled by a CAC-A restrike algorithm, in the preferred embodiment. If current is detected within a CAC-A delay time of an outage, the algorithm determines it is restrike and transitions to the CAC-A weld start state. If current (or an arc) is detected within the CAC-A hot start delay time, then the CAC-A hot start (described above) is provided. The CAC-A hot start delay time is at least 150 msec and preferably about 200 msec. It is be more or less than 200 msec, in other embodiments. The time should be selected so that the welding-type power supply provides a hot start when needed, but not when restriking CAC-A hot start delay time, as used herein is a delay time during which hot start current is not provided after an arc outage, when in a CAC-A mode.

A CAC-A start state is provided in the CAC-A mode in the preferred embodiment. The CAC-A start state includes providing a CAC-A start current after the hot start or when the hot start is omitted. The CAC-A start current is provided for a CAC-A start current time. The preferred embodiment has a CAC-A start current of about 1.125 times the set point and the CAC-A start current time is about 10 msec in the preferred embodiment. If the output voltage is less than the CAC-A dig threshold the CAC-A start current is provide for an extended time, preferably until the voltage rises above the CAC-A dig threshold, or for a fixed period of time. Alternatives provide for using other CAC-A start currents, other CAC-A start current times, omitting the extended time, and/or using a different threshold. CAC-A start current, as used herein is the output current after the hot start or when the hot start is omitted, when in a CAC-A mode. CAC-A start current time, as used herein is time during which the CAC-A start current is provided.

When in the CAC-A mode, the output current slew rate is limited (relative to the stick slew rate) following the initial CAC-A hot start or CAC-A start state, in the preferred embodiment. The slew rate is preferably limited to about 125 amps/msec, or less than 200 amps/msec in various embodiments. Alternative include providing other slew rates, including a slew rate typical of CV processes. CAC-A slew rate, as used herein is the rate at which output current increases at the start of normal operation (after the hot start, etc.) when in a CAC-A mode. Stick slew rate, as used herein is the rate at which output current increases at the start of normal operation (after the hot start., etc) when in a stick mode.

Alternatives provide that one or more of the above states may be omitted or modified, but that CAC-A power is still provided by the welding-type power supply. CAC-A power, as used herein, is power suitable for CAC-A.

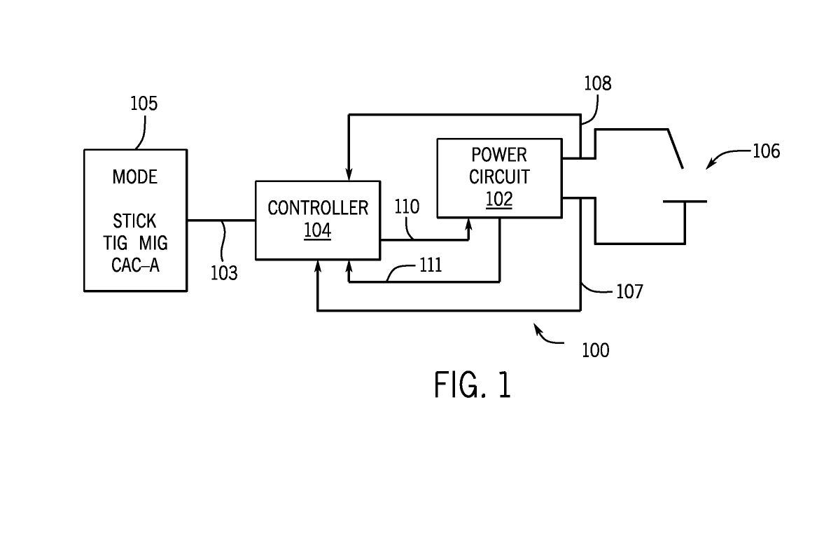

The above CAC-A mode is implemented, in the preferred embodiment, using digital PWM control of the output of a welding type power supply to provide a desirable output for CAC-A when in a CAC-A mode. A welding type power supply 100 (FIG. 1) includes, in the preferred embodiment, a power circuit 102, a controller 104 and a mode selector 105. The output of power circuit 104 is a welding or CAC-A arc 106. Power supply 100 may be a multi-process welding type power supply, but the present invention will be explained with reference to a CAC-A mode of operation. Controller, as used herein, is digital or analog circuitry, software, and components that cooperate to control a welding type power supply. They may be in one location, or may be distributed over several locations.

Controller 104 is preferably a digital pulse width controller, such as that described in U.S. Pat. No. 8,455,794. Controller 104 may also be such as that described in US-2014-0021180-A1. Alternatives provide for an analog controller, a digital controller with discrete elements, a controller using DSPs, and a controller using other circuitry.

Power circuit 102 is preferably the power circuit shown in US-2014-0021180-A1, which includes a preregulator, a high voltage split bus, and, as an output converter, a stacked full bridge inverter output circuit. It may also be implemented using the power circuit shown in U.S. Pat. No. 8,455,794. Alternatives provide for using the output circuit (stacked inverters) without the preregulator, a half bridge output converter, or other output converters, such as a chopper, buck, etc., and using intermediates stages.

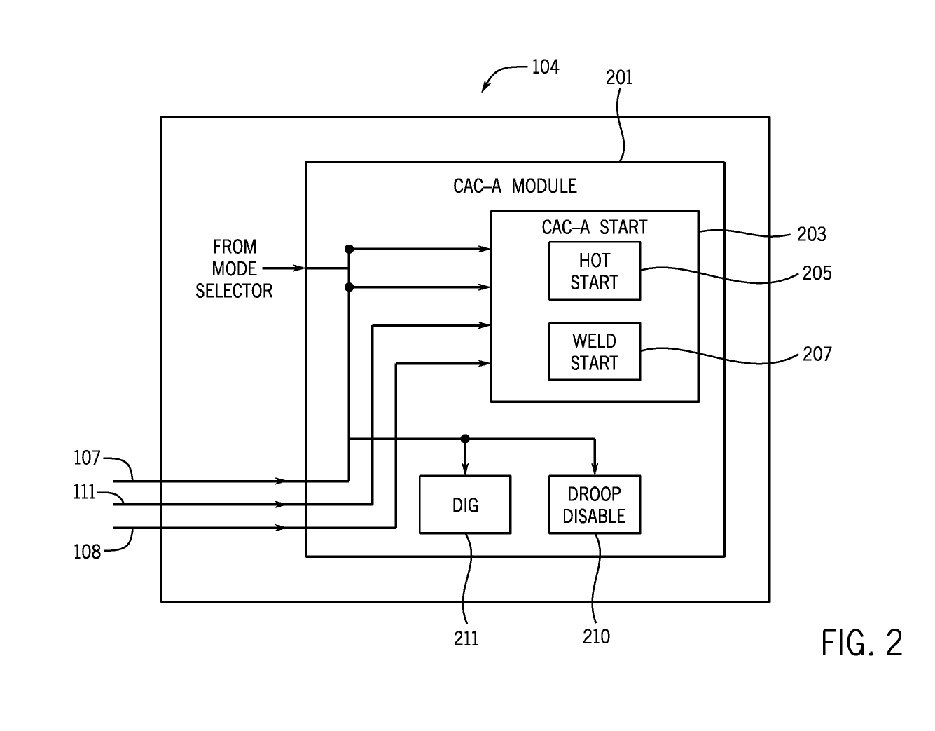

Controller 104 is responsive to mode selector 105, via line 103. When mode selector 105 selects the CAC-A mode, controller 105 implements a number of software modules (described below) that cause the output of welding-type power supply 100 to be particularly suited for CAC-A, as described above. Controller 104 is shown in more detail in FIG. 2, and includes a CAC-A control module 201. Module, as used herein includes software and hardware that cooperate to perform a given function. CAC-A control module (or CAC-A module), as used herein is a control module that causes a welding-type power supply to provide an output that is dedicated to CAC-A. CAC-A control module 201 is implemented using software in the preferred, but is implemented using discrete components and/or hardware in other embodiments.

CAC-A control module 201 includes a CAC-A start module 203, a CAC-A dig module 211 and a droop disable module 210. CAC-A start module 203 includes an increased hot start module 205 and a weld start module 207. When the CAC-A mode is selected CAC-A start module 203 is activated and implements the scheme described above for CAC-A starts. Droop disable module 210 disables the droop usually provided for a stick mode. Also, CAC-A dig module 211 provides a CAC-A dig threshold of about 25 volts and a CAC-A dig slope of about 30 amps/volt. When in the normal CAC-A mode of operation (after start and/or restrike) CAC-A control module 201 limits the output current slew rate, preferably to about 125 amps/msec, in response to feedback on feedback line 111. CAC-A dig module, as used herein is a control module that causes a welding-type power supply to provide a dig output below a dig threshold, when in a CAC-A mode. Droop disable module, as used herein is a control module used in CAC-A to disable the droop feature of a welding-type power supply.

CAC-A control module 201 uses CAC-A start module 203 to implement the start and restrike schemes above. CAC-A increased hot start module 205 monitors the output, using feedback lines 107, 108 and/or 111, after an outage. If current does not flow (or an arc is not detected) for a hot start delay time of about 200 msec, then the hot start mode is entered and CAC-A hot start module 205 causes a hot start current of about twice the stick hot start current to be provided. CAC-A hot start module 205 causes the CAC-A hot start current to be provided for the CAC-A hot start time, preferably about 100 msec. The CAC-A hot start time is extended by CAC-A hot start module if the output voltage from feedback lines 107 and 108 is below the CAC-A dig threshold. After the CAC-A hot start current ends (100 msec, e.g.), CAC-A start module 207 takes over the process. Also, If CAC-A hot start module detects current flow with the 200 msec CAC-A hot start delay time, CAC-A start module 207 takes over the process. CAC-A start module, as used herein is a control module used when current flow is to be established and in CAC-A mode.

CAC-A start module causes the output current to be the CAC-A start current, preferably at least 10% and more preferably about 12.5% greater than the setpoint, for the CAC-A start current time, preferably about 10 msec. If the output voltage on feedback lines 107 and 108 is less than the CAC-A dig threshold, then CAC-A start module 207 causes the CAC-A start current to be provided for an extended time, preferably until the voltage rises above the CAC-A dig threshold.

Numerous modifications may be made to the present disclosure which still fall within the intended scope hereof. Thus, it should be apparent that there has been provided a method and apparatus for providing welding-type power in a CAC-A mode that fully satisfies the objectives and advantages set forth above. Although the disclosure has been described specific embodiments thereof, it is evident that many alternatives, modifications and variations will be apparent to those skilled in the art. Accordingly, the invention is intended to embrace all such alternatives, modifications and variations that fall within the spirit and broad scope of the appended claims.

The embodiments of the invention in which an exclusive property or privilege is claimed are defined as follows:

1. A method of air carbon arc cutting (CAC-A) using a welding-type power supply to provide an output, comprising:
having a selected CAC-A mode and a selected current setpoint;
disabling stick droop in the output;
setting a CAC-A dig slope that is greater than a stick dig slope;
setting a CAC-A dig threshold that is greater than a stick dig threshold;
setting a CAC-A hot start current that is greater than a stick hot start current;
setting a CAC-A hot start time;
setting a CAC-A hot start delay time;
setting a CAC-A start current that is greater than the current set point;
setting a CAC-A start current time;
setting a CAC-A slew rate that is less than a stick slew rate; and
providing power using the welding-type power supply, wherein
1) when an open circuit is detected and then current is detected within the hot start delay time, the CAC-A start current is provided for the CAC-A start current time, and thereafter when the current is above the CAC-A dig threshold the current provided is increased at the CAC-A slew rate until the current is provided at the current setpoint;
2) when an open circuit is detected and current is not detected within the hot start delay time, providing a hot start current for the CAC-A hot start time; and
3) when an open circuit is detected and current is not detected within the hot start delay time and the output voltage is less than the CAC-A dig threshold, increasing the CAC-A hot start time.

2. The method of claim 1, wherein:
setting the CAC-A dig slope includes setting the CAC-A dig slope to at least 24 amps/volt;
setting the CAC-A dig threshold includes setting the CAC-A dig threshold to at least 23 volts;
setting the CAC-A hot start current includes setting the CAC-A hot start current to about twice the current set point;
setting the CAC-A hot start time includes setting the CAC-A hot start time to be about 100 msec;
setting the CAC-A hot start delay time includes setting the CAC-A hot start delay time to at least 150 msec;
setting the CAC-A start current includes setting the CAC-A start current to be at least 10% is greater than the current set point;
setting the CAC-A start current time includes setting the CAC-A start current time to be about 10 msec; and
setting the CAC-A slew rate includes setting the CAC-A slew rate to be about 125 amps/msec.

3. A method of air carbon arc cutting (CAC-A) using a welding-type power supply to provide an output, comprising having a user selected CAC-A mode and providing current in a CAC-A mode at a selected current setpoint.

4. The method of claim 3, further comprising disabling stick droop in the output.

5. The method of claim 4, further comprising setting a CAC-A dig slope that is greater than a stick dig slope and setting a CAC-A dig threshold that is greater than a stick dig threshold, and providing the output at the dig slope when the output voltage is less than the dig threshold.

6. The method of claim 5, wherein setting the CAC-A dig slope includes setting the CAC-A dig slope to about 30 amps/volt and setting the CAC-A dig threshold includes setting the CAC-A dig threshold to about 25 volts.

7. The method of claim 4, further comprising:
setting a CAC-A hot start current that is greater than a stick hot start current;
setting a CAC-A hot start time;
setting a CAC-A hot start delay time; and
when an open circuit is detected and current is not detected within the hot start delay time providing a hot start current for the CAC-A hot start time.

8. The method of claim 7, wherein setting the CAC-A hot start current includes setting the CAC-A hot start current to about twice the current set point, and setting the CAC-A hot start time includes setting the CAC-A hot start time to be about 100 msec, and setting the CAC-A hot start delay time includes setting the CAC-A hot start delay time to be about 200 msec.

9. The method of claim 7, further comprising when an open circuit is detected and current is not detected within the hot start delay time and the output voltage is less than the CAC-A dig threshold, increasing the CAC-A hot start time.

10. The method of claim 7, further comprising when an open circuit is detected and then current is detected within the hot start delay time, a CAC-A start current is provided for a CAC-A start current time, and thereafter the current provided is increased at a CAC-A slew rate until the current is provided at the current setpoint.

11. The method of claim 10, wherein setting the CAC-A start current includes setting the CAC-A start current to be about 12.5% greater than the current set point, and setting the CAC-A start current time includes setting the CAC-A start current time to be about 10 msec, and setting the CAC-A slew rate includes setting the CAC-A slew rate to be about 125 amps/msec.

12. The method of claim 10, wherein setting the CAC-A start current includes setting the CAC-A start current to be about 12.5% greater than the current set point, and setting the CAC-A start current time includes setting the CAC-A start current time to be about 10 msec, and setting the CAC-A slew rate includes setting the CAC-A slew rate to be about 200 amps/msec.

13. A welding-type power supply comprising:
a user mode selector, including an air carbon arc cutting (CAC-A) mode;
a power circuit, disposed to receive an input power and provide CAC-A power, and having a control input; and
a controller, having a control output connected to the control input, wherein the controller has a CAC-A control module responsive to the CAC-A mode, and having a feedback input indicative of the output current and indicative of the output voltage.

14. The welding-type power supply of claim 13, wherein the CAC-A control module includes a CAC-A start module.

15. The welding-type power supply of claim 14, wherein the CAC-A control module includes a CAC-A dig module having a dig threshold that is greater than a stick dig threshold, and having a dig slope.

16. The welding-type power supply of claim 14, wherein the CAC-A start module includes a CAC-A hot start current that is greater than a stick hot start current, a CAC-A hot start time, a CAC-A hot start delay time, responsive to the feedback input.

17. The welding-type power supply of claim 15, wherein the CAC-A start module includes a CAC-A increased hot start module, responsive to the output voltage being less than a CAC-A dig threshold.

18. The welding-type power supply of claim 17, wherein the CAC-A start module includes a weld start module having a CAC-A start current time and a CAC-A slew rate, and responsive to the feedback input.

19. The welding-type power supply of claim 18, wherein the CAC-A control module includes a droop disable module.

20. A welding-type power supply for air carbon arc cutting (CAC-A), comprising:
means for providing welding-type power;
user select means for selecting a plurality of modes, including a CAC-A mode;
control means, for controlling the means for providing welding-type power, wherein the control means is responsive to the user select means.

21. The welding-type power supply of claim 19, wherein the control means includes means for disabling stick droop in the output.

22. The welding-type power supply of claim 20, wherein the control means includes means for setting a CAC-A dig slope that is greater than a stick dig slope and setting a CAC-A dig threshold that is greater than a stick dig threshold, and for providing the output at the dig slope when the output voltage is less than the dig threshold.

23. The welding-type power supply of claim 22, wherein the control means includes means for setting a CAC-A hot start current that is greater than a stick hot start current, for setting a CAC-A hot start time, for setting a CAC-A hot start delay time, and for providing a hot start current for the CAC-A hot start time when an open circuit is detected and current is not detected within the hot start delay time.

24. The welding-type power supply of claim 23, wherein the control means includes means for increasing the CAC-A hot start time in response to an open circuit being detected and current not being detected within the hot start delay time and the output voltage being less than the CAC-A dig threshold.

25. The welding-type power supply of claim 24, wherein the control means includes means fora CAC-A start current is provided for a CAC-A start current time and thereafter the current provided is increased at a CAC-A slew rate until the current is provided at the current setpoint, when an open circuit is detected and then current is detected within the hot start delay time.
